(19) United States
(12) Patent Application Publication
(10) Pub. No.: US 2009/0055393 A1
(43) Pub. Date: Feb. 26, 2009

(54) METHOD AND SYSTEM FOR FACILITATING INFORMATION SEARCHING ON ELECTRONIC DEVICES BASED ON METADATA INFORMATION

(75) Inventors: Alan Messer, Los Gatos, CA (US); Phuong Nguyen, San Jose, CA (US)

Correspondence Address: MYERS DAWES ANDRAS & SHERMAN, LLP, 19900 MACARTHUR BLVD., SUITE 1150, IRVINE, CA, 92612, US

(73) Assignee: Samsung Electronics Co., Ltd., Gyeonggi-Do (KR)

(21) Appl. No.: 12/263,089

(22) Filed: Oct. 31, 2008

Related U.S. Application Data
(63) Continuation-in-part of application No. 11/969,778, filed on Jan. 4, 2008.
(60) Provisional application No. 61/022,485, filed on Jan. 21, 2008.
(60) Provisional application No. 60/898,257, filed on Jan. 29, 2007.

(51) Int. Cl. G06F 17/30

(52) U.S. Cl. 707/5

(57) ABSTRACT

A method and system for facilitating information searching for a user of an electronic device is provided. One implementation involves, on a client side, obtaining metadata for content accessed by a user via the electronic device, displaying terms based on said metadata for user selection, receiving a user selection including receiving selection of one or more of said terms from the user, forming a query based on the user selection to search for related data, and extracting data of interest to the user based on said query.

### CROSS REFERENCE TO RELATED APPLICATIONS

This application claims priority from U.S. Provisional Patent Application Ser. No. 61/022,485, filed on Jan. 21, 2008, incorporated herein by reference. This application is further a Continuation-in-Part of U.S. patent application Ser. No. 11/969,778 filed on Jan. 4, 2008, which in turn claims priority from 60/898,257, filed on Jan. 29, 2007, incorporated herein by reference.

### FIELD OF THE INVENTION

The present invention relates to providing relevant information to users, and in particular to providing relevant information to users with reduced user input.

### BACKGROUND OF THE INVENTION

The Internet has become a popular source of entertainment and information. Most Internet content is designed for access via a web browser, making it difficult for access via most consumer electronics (CE) devices which lack typical computer keyboards. As a result, the Internet is generally restricted to access on personal computers (PC) or via cumbersome interfaces on CE devices.

With advances in hardware and software technologies, CE devices are becoming more powerful. Growth in network infrastructure and the falling prices of hardware have increased the availability of network-capable entertainment devices. Many users are configuring home networks including cable set-top boxes, digital television sets, home media servers, digital audio players, personal video recorders, etc. Home network consumers are also creating, storing and accessing more digital content through CE devices and PCs.

A second trend, running in parallel to the emergence of networked entertainment devices, is the growing use of the Internet for creating and publishing content. Greater broadband penetration and falling memory prices are enabling users to move ever larger media files, such as television (TV) shows and full-length movies, through the Internet.

However, there is a gap between the digital content on the Internet and the networked digital entertainment devices in that most Internet content is structured and organized for access via a web browser not a typical CE device. For example, typically a user searches for Internet information using a search engine or by directly accessing a known website via a PC. When using a search engine, the user is required to form an initial query and then iteratively refine the query depending upon the results obtained. As such, the user is forced to comprehend and analyze large quantities of information to identify/access the exact information the user is looking for. This process may work on a PC, but on CE devices that lack a keyboard and a mouse, the searching/refinement process is awkward and unpleasant.

### BRIEF SUMMARY OF THE INVENTION

The present invention provides a method and system for facilitating information searching for a user of an electronic device. One embodiment includes, on a client side, obtaining metadata for content accessed by a user via the electronic device, displaying terms based on said metadata for user selection, receiving a user selection including receiving selection of one or more of said terms from the user, forming a query based on the user selection to search for related data, and extracting data of interest to the user based on said query.

These and other features, aspects and advantages of the present invention will become understood with reference to the following description, appended claims and accompanying figures.

### BRIEF DESCRIPTION OF THE DRAWINGS

FIG. 1 shows a network implementing a process for facilitating information searching for users, according to an embodiment of the present invention.

FIG. 2 shows an example architecture for facilitating information searching, according to the invention.

FIG. 3 shows a flowchart of the overall steps involved in facilitating information searching, according to the invention.

FIG. 4 shows a process for facilitating information searching for users, according to an embodiment of the present invention.

FIG. 5 shows another example architecture for facilitating information searching, according to the invention.

### DETAILED DESCRIPTION OF THE INVENTION

The present invention provides a method and system for facilitating access to information via electronic devices such as consumer electronic (CE) devices. One embodiment involves a process for enabling users to easily find and access Internet content related to content presented on a CE device. An example is enabling a user to easily find and access Internet content related to a program the user is watching on a television.

The process may utilize local information which may include contextual information and/or non-contextual information, available to the electronic device. Contextual information may include user context (e.g., user actions, history, profile) or device context (e.g., current content accessed by the device or in the network, metadata such as closed-captions, Electronic Programming Guide (EPG)).

One implementation provides a process including identifying terms (e.g., topics, keywords) in metadata of content accessed by the user via the device (e.g., a TV program displayed on a TV), enabling the user to select among the topics, and then obtaining related information for the user. In one example, the user selects topics from the closed-caption stream (or a likely filtered stream) of a TV program, which are then utilized to obtain related information such as related information from the Internet.

An example system implementing said process assists a user watching a TV program to obtain keywords from a video stream from filtered text sources such as closed-captions, based on user selections. The user interacts with the system to extract and use program topics for obtaining related information. For example, the system assists the user in selecting topics from a filtered version of the closed-caption stream of a TV program. In doing so, one or more topic keywords are selected by the user and then combined into a query for internet content (such as an Internet search query that may be submitted to a search engine).

Searching for information on the Internet typically involves two stages: search query formation, and data search and analysis. Query information involves forming a search query that describes the type of information being sought. Data search and analysis involves resolving the search query according to the following steps: potential sources of data are identified; relevant data from such sources are extracted via search queries and then aggregated (collected); and correlations in the form of associations among the aggregated data are identified to make the results more meaningful.

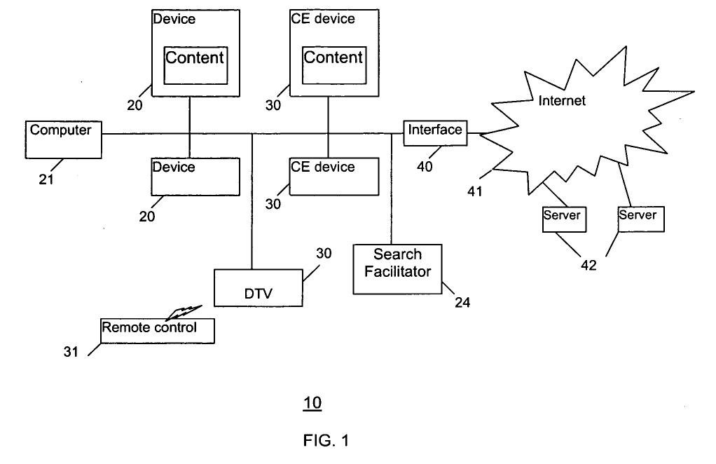

An example implementation for CE devices in a local area network (LAN), such as a home network, is described below, however the present invention is useful with other electronic devices, and electronic devices that are not in a LAN but have access to the Internet. FIG. 1 shows a functional architecture of an example network/system 10, such as a LAN of home devices, embodying aspects of the present invention. The network/system 10 comprises devices 20 such as appliances, a personal computer (PC) 21, CE devices 30 which may include content, and an interface 40 that connects the network/system 10 to an external network 41 (e.g., another local network, the Internet). The external network 41 can be connected to one or more servers 42. The network/system 10 can implement the Universal Plug and Play (UPnP) protocol or other network communication protocols (e.g., Jini, HAVi, IEEE 1394, etc.). The network/system 10 can be a wireless network, a wired network, or a combination thereof. Examples of CE devices include digital televisions (DTVs, PDAs, media players, etc.).

The network 10 further includes a search facilitator system 24 that provides searching, aggregation and analysis functions. The facilitator 24 performs query formation, data search and analysis, wherein query formation includes enabling a user to select topics from a filtered version of content metadata, combining user selections into a query and searching data sources and analyzing results for information based on the query. Data search and analysis includes extracting, aggregating and correlating data of interest using execution plans.

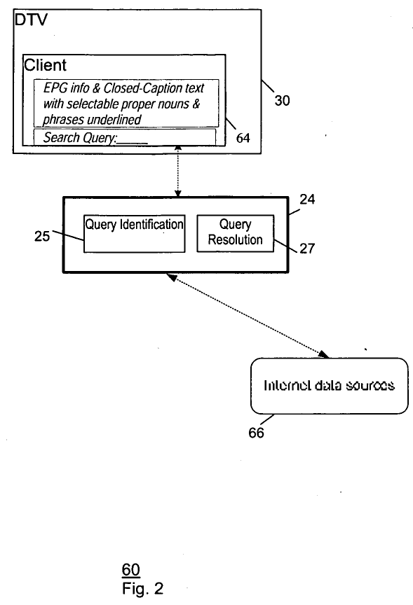

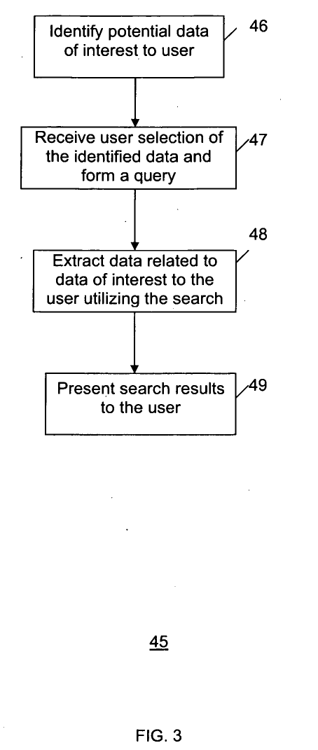

FIG. 2 shows an architecture 60 including the facilitator 24, according to an embodiment of the present invention. The architecture 60 implements searching, aggregation and analysis functions via the facilitator 24, to provide information to a user through a user interface of a client module 64 that, in this example, is implemented in a CE device such as the DTV 30. Referring to the example process 45 in FIG. 3, the facilitator 24 identifies information of potential interest to the user (step 46), receives user selections among the identified data from a user interface and forms a search query based on the selections (step 47), extracts data related to data of interest to the user utilizing the search query (step 48), aggregates the extracted data (optionally correlates the data) and presents to the extracted date to the user on a user interface (step 49). Information of interest to the user may include, for example, content previously/currently accessed by the user, selections previously made by the user, etc.

In one example, the client module 64 enables the user to obtain desired information from, e.g., the Internet using a simple and intuitive Graphical User Interface (GUI) application, utilizing the facilitator 24, including:
1. Mapping the functionalities that support an information search to a small number of keys (e.g., mapping such functionalities to a few keys of a TV remote control 31 (FIG. 1), as an example for receiving user input when using a DTV 30 for information access).
2. Enabling the user to express interest in obtaining additional information related to information currently accessed by the user (e.g., providing an “info.” button on the remote control 31 for the user to press, and mapping this action into a “more info” request, etc.).
3. Enabling the user to indicate the specific type of additional information the user is looking for, after the user has expressed interest in accessing additional information. An example involves displaying text of EPG information for the current viewing program and current program closed caption. The system identifies keywords (e.g., proper nouns and nouns), highlights them, and make them selectable. Then, a combination of keys (e.g., up/down/right/left arrow keys) on a remote control 31 are provided for the user to select single or multiple keywords to compile a search query.
4. Enabling the user to refine or edit a suggested keyword/search query, such as by displaying a set of additional query suggestions that contain, or are related to, the selected keyword and providing a combination of the arrow keys (up/down/right/left arrows) on the remote control 31 for the user to select one of the query suggestions. The GUI allows the user to refine the search queries as many times as the user desires by just repeating the process described above. Further, the query suggestions are displayed in an editable text box that allows the user to delete existing characters or enter new characters to modify the query as desired. This can be performed using, e.g., a wireless keyboard or a remote control that has an inbuilt keypad.
5. Performing a search based on a formulated query. Then, enabling the user to access the search results by displaying a list of search results corresponding to the keyword previously selected by the user. Then, providing a combination of arrow keys (up/down/right/left arrows) on the remote control device 31 for the user to select one of the refined search results. An example of a search result includes a link to a web page containing information about the search query, wherein the title of the web page is displayed to the user on the GUI.
6. Enabling the user to select text (e.g., proper nouns and nouns) in the search results box to further compile new search query.

The user utilizes the client module 64 to access certain content, and the facilitator 24 obtains information related to the accessed content for display to the user. The user may then requests that the facilitator 24 provide more information about the accessed content. For example, the user utilizes the client module 64 to request that the facilitator 24 provide more information from Internet data sources 66 about a pre-recorded/broadcast TV program the user is watching on the DTV 30.

Using the client module 64, the user can choose, edit or enter new queries (such as the suggested keywords/categories) with minimal effort on a CE device that may not have a keyboard/mouse. Specifically, the facilitator 24 suggests and displays queries including keywords related to the TV program and information related to those keywords. Using the suggested keywords as search queries, users can seamlessly browse/search for related information available on the Internet through their CE devices by simply selecting among the suggested queries for searching. The facilitator 24 identifies many relevant search queries, and allows the user to edit a suggested query or enter a new query. The facilitator 24 then obtains information of interest to the user and presents such information to the user.

In one implementation, when the user presses the “More Info” button, the user is presented with a text box containing EPG information and a set of current CC sentences/phrases with underlined proper nouns/noun phrases. Then, as the user moves the Left/Right/Up/Down key, the “cursor” (e.g., a highlight frame around current underline word(s)) moves from one underlined word to the next one, as illustrated by the example in Table 1 below:

TABLE 1
Selection Example

Step 1 (user presses Info key):
[Republican] vice presidential candidate Sarah Palin has said Obama was
“palling around with terrorists” and referred to Ayers, an education
professor.
Search Query:
Step 2 (user presses Right key):
Republican vice [presidential candidate] Sarah Palin has said Obama was
“palling around with terrorists” and referred to Ayers, an education
professor.
Search Query:
Step 3 (user presses a “select” key)
Republican vice [presidential candidate] Sarah Palin has said Obama was
“palling around with terrorists” and referred to Ayers, an education
professor.
Search Query: presidential candidate
Step 4 (user press Down key):
Republican vice presidential candidate Sarah Palin has said [Obama] was
“palling around with terrorists” and referred to Ayers, an education
professor.
Search Query: presidential candidate
Step 5 (user presses some “Select” key):
Republican vice presidential candidate Sarah Palin has said [Obama] was
“palling around with terrorists” and referred to Ayers, an education
professor.
Seacrh Query: presidential candidate Obama
Step 6 (user presses the Info Key again or some Search key):
System executes the search query: “presidential candidate Obama”

In the architecture shown in FIG. 2, the facilitator 24 includes a query identification function 25 and a query resolution function 27, which implement the above steps. Specifically, the query identification function 25 identifies potential data of interest to the user. The query resolution function 27 presents identified data of potential interest to the user (e.g., Internet sources 66), aggregates the extracted data and correlates the aggregated data for presentation to the user. The operations of the query identification function 25 and the query resolution function 27 are described below.

When a user accesses content such as broadcast TV programs and DVDs, the query identification function 25 uses the caption data (closed captions), that is embedded in the content stream, to identify potential search queries. This embedded caption data contains useful information in the form of keywords.

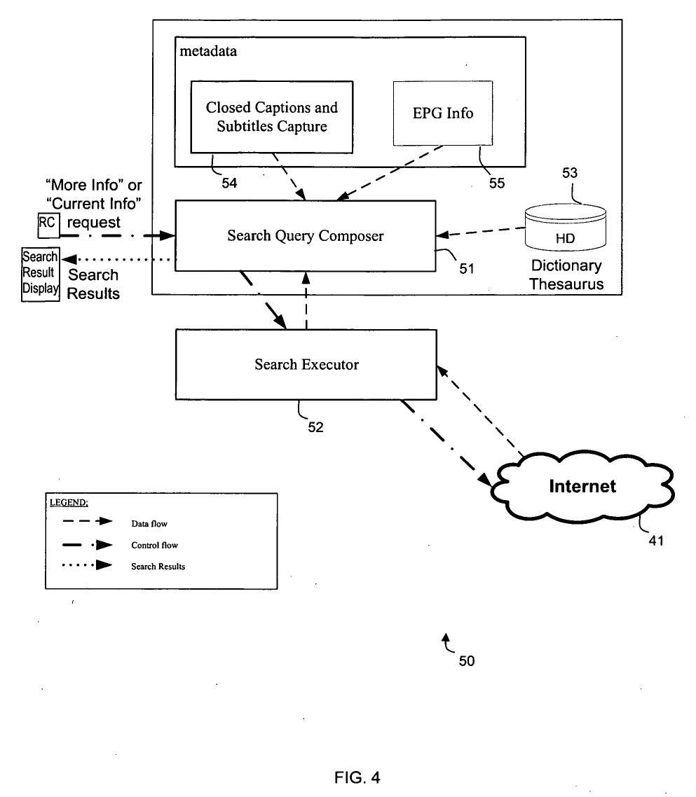

FIG. 4 shows an example system 50 for facilitating information searching for users, according to an embodiment of the present invention. Topics of interest from CC information 54 and EPG information 55 of a program are filtered and provided to a search query composer 51. The search query composer 51 assists the user in selecting from the topics and or select words/topics from a dictionary 53. In doing so, one or more topic keywords, and optionally other words, are selected by the user (e.g., via a menu/user interface) and then combined into a query by the search query composer 51 for searching for related content, (such as an Internet search query that may be submitted to a search engine). A search executor 52 then submits the query for data extraction e.g. from the Internet. The search results are gathered by the search executor 52 and provided to the search query composer 51 to present to the user (e.g., via a menu/user interface).

In one example scenario, the user is watching a program on a TV 30. A text segment of metadata associated with that program is accumulated into a buffer (e.g., closed captions and EPG text).

Then, when the user wants to find out more information, the “More Info” button (e.g., on the RC 31, FIG. 1) or other means of summoning a corresponding menu is activated. The system then displays current EPG information and the last few sentences accumulated in the buffer. A cursor is placed on the latest identified keyword. The user is then able to cursor left and right using the RCE 31 to move the cursor and press select to add words to a Search Query Text Box to compile a new search query. Once the user completes adding words to the Search Query Text Box, the user presses a key to request related internet information.

The search query compilation process may involve the use of a built-in thesaurus/antonym dictionary to pull in different words. For example, if the keyword happens to be “women coat”, the user can select the word “woman” and use the corresponding antonym to search for “man coat”. Requested information can either be a generic search request or a request to a specific content source. As an example, the user may see the following words in the buffer: “Iraq”, “around”, “President” and “Bush”. The user may then select “Bush” “President” and “Iraq” by moving around on the screen and when selected, find information on “Iraq President Bush” as a search query to be submitted for searching.

In one example, when a user watches a TV program and expresses interest to access related content, the query identification function 25 analyzes the TV program's caption text to identify significant keywords and suggests them to the user as possible search queries.

The facilitator 24 can be implemented, e.g., in a stand-alone module, in a device 20 such as a set-top box or in a CE device 30 such as a DTV. The query identification function 25 can be implemented, e.g., in a stand-alone module, in a device 20 such as a set-top box or in a CE device 30 such as a DTV. The query resolution function 27 can be implemented, e.g., in a stand-alone module, in a device 20 such as a set-top box or in a CE device 30 such as a DTV. A user interface (UI) can be displayed on a device in the network/system 10 capable of displaying information, such as a CE device 30.

The client user interface lists nouns/pronouns from the last few CC sentences; alternatively, available as a different user interface (UI) screen, the user selects the highlighted nouns/pronouns or any words from the original CC text to compile a search query. The system identifies nouns and proper nouns from CC data by referencing its lists of “all” nouns and “known” proper nouns (can be updated via a dedicated web server).

The process further involves obtaining information embedded in broadcast streams that are accessible only by a receiving/rendering CE device (e.g., subtitles and closed captions).

Obtaining additional information may include obtaining the additional information from external unstructured data sources, from external semi-structured data sources, or from external broadcast data sources.

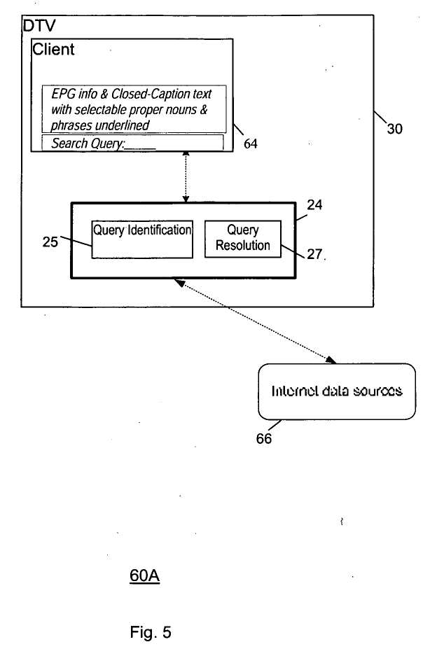

FIG. 5 shows another example architecture 60A for facilitating information searching, according to the invention, wherein the facilitator 24 is a component of the CE device 30.

As is known to those skilled in the art, the aforementioned example architectures described above, according to the invention, can be implemented in many ways, such as program instructions for execution by a computer comprising a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements. Though the invention has been described with reference to certain versions thereof; however, other versions are possible. Therefore, the spirit and scope of the appended claims should not be limited to the description of the preferred versions contained herein.

The terms “computer program medium,” “computer usable medium,”, “computer readable medium”, and “computer program product”,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium, such as a network link and/or a network interface, including a wired network or a wireless network, which allows a computer to read such computer readable information. Computer programs (also called computer control logic) are stored in main memory and/or secondary memory. Computer programs may also be received via a communications interface. Such computer programs, when executed, enable the computer system to perform the features of the invention as discussed herein. In particular, the computer programs, when executed, enable the processor multi-core processor to perform the features of the computer system. Accordingly, such computer programs represent controllers of the computer system.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for facilitating information searching for a user of an electronic device, comprising, on a client side:
obtaining metadata for content accessed by a user via the electronic device;
displaying terms based on said metadata for user selection;
receiving a user selection including receiving selection of one or more of said terms from the user;
forming a query based on the user selection to search for related data; and
extracting data of interest to the user based on said query.

2. The method of claim 1 further including displaying said extracted data of interest to the user and receiving query refinement form the user.

3. The method of claim 1 wherein extracting data of interest to the user based on said query further includes causing execution of the query on a server side to search for related information on one or more of: a client network, a server network and Internet.

4. The method of claim 3 further comprising, on the server side executing the query and providing search results based thereon.

5. The method of claim 1 wherein displaying terms based on said metadata for user selection, further includes filtering the metadata by performing one or more of: dictionary checks to only allow nouns/proper nouns.

6. The method of claim 5 wherein filtering the metadata further includes filtering metadata based on one or more of: user context and filtering based on device context.

7. The method of claim 1 wherein receiving a user selection further includes receiving additional terms from the user, such that forming a query further includes forming a query based on said selected terms and said additional terms.

8. The method of claim 1, wherein the device comprises a consumer electronics device.

9. A computer program product for facilitating information searching for a user of an electronic device, comprising a computer usable medium including a computer readable program including instructions, wherein the computer readable program when executed on a computer causes the computer to:
obtain metadata for content accessed by a user via the electronic device;
display terms based on said metadata for user selection;
receive a user selection including receiving selection of one or more of said terms from the user;
form a query based on the user selection to search for related data; and
extract data of interest to the user based on said query.

10. The computer program product of claim 9 further including instructions for displaying said extracted data of interest to the user and receiving query refinement form the user.

11. The computer program product of claim 9 further including instructions for causing execution of the query on a server side to search for related information on one or more of: a server network and Internet.

12. The computer program product of claim 9 further including instructions for filtering the metadata by performing one or more of: dictionary checks to only allow nouns/proper nouns.

13. The computer program product of claim 12 further including instructions for filtering metadata based on one or more of: user context and filtering based on device context.

14. The computer program product of claim 9 further including instructions for receiving additional terms from the user and forming a query based on said selected terms and said additional terms.

15. The computer program product of claim 9 wherein the device comprises a consumer electronics device.

16. A system for facilitating information searching for a user, comprising:
an electronic device configured for operating at a client side for access to content; and
a facilitator configured for operating at the client side, the facilitator including:
a search query composer configured for obtaining metadata for content accessed by a user via the electronic device, displaying terms based on said metadata for user selection, receiving a user selection including receiving selection of one or more of said terms from the user, and forming a query based on the user selection to search for related data; and
a search executor configured for extracting data of interest to the user based on said query.

17. The system of claim 16 wherein the search executor is further configured for causing execution of the query on a server side to search for related information on one or more of: a client network, a server network and Internet.

18. The system of claim 16 wherein the search query composer is further configured for filtering the metadata by performing one or more of: dictionary checks to only allow nouns/proper nouns.

19. The system of claim 17 wherein the search query composer is further configured for filtering metadata based on one or more of: user context and filtering based on device context.

20. The system of claim 16 wherein the search query composer is further configured for receiving additional terms from the user, and forming a query based on said selected terms and said additional terms.

21. The system of claim 16 wherein the device comprises a consumer electronics device.

22. The system of claim 16 wherein the search executor is further configured for causing execution of the query on a server side to search for related information on one or more of: a server network and Internet; and providing search results to the search query composer for presentation to the user.

23. The system of claim 16 wherein the facilitator is a component of the electronic device.
